(19) United States
(12) Patent Application Publication
(10) Pub. No.: US 2025/0053970 A1
(43) Pub. Date: Feb. 13, 2025

(54) BLOCKCHAIN TRANSACTION

(71) Applicant: nChain Licensing AG, Zug (CH)

(72) Inventors: Liuxuan PAN, London (GB); Craig Steven WRIGHT, London (GB)

(21) Appl. No.: 18/720,530

(22) PCT Filed: Nov. 17, 2022
(86) PCT No.: PCT/EP2022/082339

§ 371 Date: Jun. 14, 2024

(30) Foreign Application Priority Data
Dec. 21, 2021 (GB) 2118636.6

(51) Int. Cl. G06Q 20/38

(52) U.S. Cl. CPC G06Q 20/3829; G06Q 20/38215; G06Q 20/3825

(57) ABSTRACT

A computer-implemented method of generating a provable task for recording to a blockchain, the provable task for verifying (n+1) data items. A task blockchain transaction is generated, comprising a first locking script comprising (n+1) subscripts, each respective subscript defining a different unlocking condition corresponding to a knowledge proof, each unlocking condition being satisfied by a different one of a sequence of (n+1) verification values rᵢ, the verification value r; being derived from (i+1) data values. One or more first proof transaction templates are generated, each corresponding to a different one of the sequence of verification values, each first proof transaction template comprising a template first unlocking script and an outpoint identifying the first locking script, the template first unlocking script comprising the public key corresponding to the corresponding verification value, wherein the first unlocking script is derived from the template first unlocking script and the corresponding verification value.

### CROSS REFERENCE TO RELATED APPLICATIONS

This application is the U.S. National Stage of International Application No. PCT/EP2022/082339 filed on Nov. 17, 2022, which claims the benefit of United Kingdom Patent Application No. 2118636.6, filed on Dec. 21, 2021, the contents of which are incorporated herein by reference in their entireties.

### TECHNICAL FIELD

The present disclosure relates to a computer-implemented method of generating a provable task for recording to a blockchain, a method for generating a proof transaction, and a device and computer program for implementing the methods.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

There is a growing trend in business for enterprises to upload their data onto third-party cloud platforms. Users entrust these cloud service providers in properly storing and maintaining their data. If users require assurance of integrity of stored data, then they themselves can check the data periodically. Doing this, users need to download the entirety of the data of interest in order to verify its integrity.

However, users are often resource-constrained and unable to complete the integrity verifications in a timely manner, whereas there may exist third party workers that may be willing to be outsourced service providers for completing tasks as they are willing to spend computing resources for these verifications. Thus, users can outsource computations to these workers. However, concerns arise in outsourcing computations where a user (outsourcer) may not trust workers to correctly perform computations and, likewise, workers do not trust a user to pay for completed jobs.

A sequential payment protocol is described herein to solve the previously described payment issue. Importantly there is no trust requirement between outsourcers and workers. It is helpful for users that the outsourced verifications are efficiently verified and validly remunerated. The outsourcer submits tasks in the form of a task transaction, granting any worker the opportunity to participate in the verification tasks. For these reasons, the scheme may also be referred to as a sequential verification protocol.

The proposed protocol guarantees, regardless of the outsourcer's behaviour, that the honest workers receive the corresponding payments if they submit the correct verification results to the blockchain network. Furthermore, the protocol introduces a competition model to encourage the workers to complete the task as fast as possible.

According to one aspect disclosed herein, there is provided a computer-implemented method of generating a provable task for recording to a blockchain, the provable task for verifying (n+1) data items, the method comprising: generating a task blockchain transaction, wherein the task blockchain transaction comprises a first locking script comprising (n+1) subscripts, each respective subscript defining a different unlocking condition corresponding to a knowledge proof, wherein each unlocking condition is satisfied by a different one of a sequence of (n+1) verification values rᵢ, wherein 0≤i≤n, wherein each subscript comprises a public key corresponding to the corresponding verification values satisfying the unlocking condition of the subscript, wherein the respective subscript, when executed with a first unlocking script of a proof blockchain transaction, is configured to verify a verification value provided in the first unlocking script based on the unlocking condition, the verification value rᵢ being derived from (i+1) data values to be verified; making the task blockchain transaction available to one or more nodes of a blockchain network; generating one or more first proof transaction templates, each first proof transaction template corresponding to a different one of the sequence of verification values, each first proof transaction template comprising a template first unlocking script and an outpoint identifying the first locking script, the template first unlocking script comprising the public key corresponding to the corresponding verification value, wherein the first unlocking script is derived from the template first unlocking script and the corresponding verification value; and making the one or more first proof transaction templates available to a worker.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 schematically illustrates a relationship between a set of data values and a sequence of verification values,

FIG. 6 schematically illustrates a hierarchical structure of multi-layer proof of computation transactions;

FIG. 7 schematically illustrates verification values derivable from sets of data values, and

FIG. 8 shows an example method for outsourcing data integrity verification.

### DETAILED DESCRIPTION OF EMBODIMENTS

### 1. Example System Overview

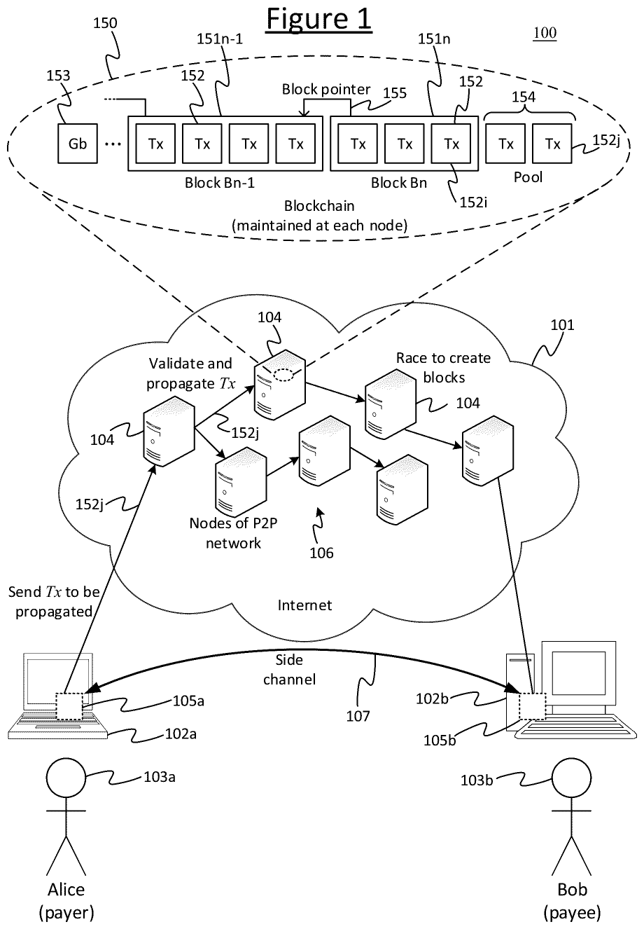

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction spends (or “assigns”), wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (or “spent”) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n−1 in the chain. The significant amount of effort, for example in the form of hash, required to create a proof-of-work solution signals the intent of the first node 104 to follow the rules of the blockchain protocol. Such rules include not accepting a transaction as valid if it spends or assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152jmeets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

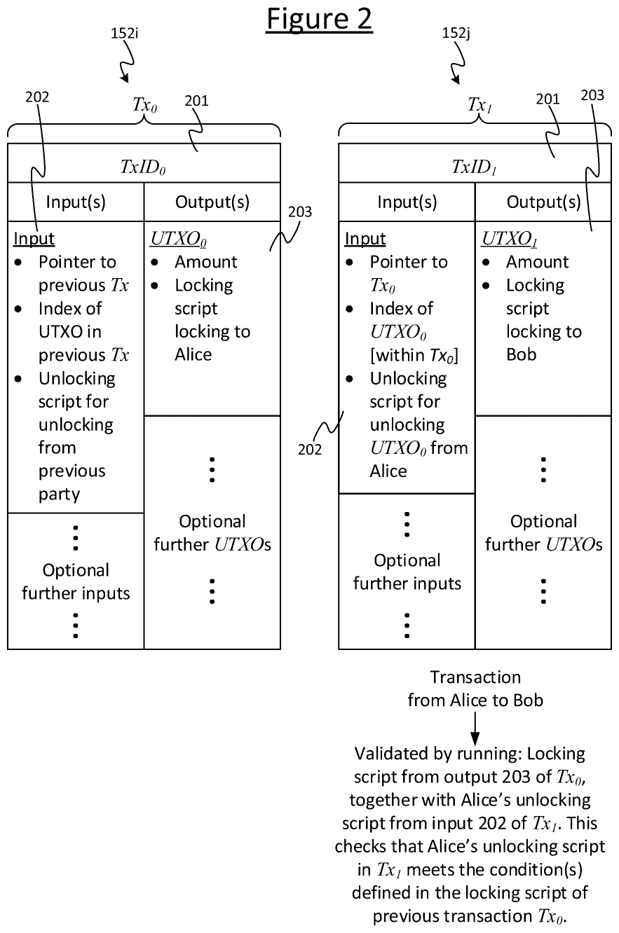

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}><PA>∥[Checksig P_{A}]

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned (or spent) by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Client Software

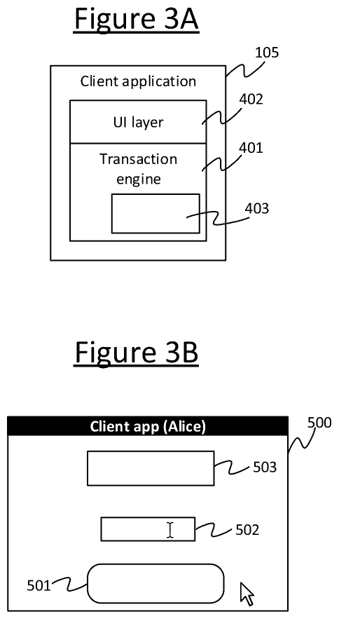

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly. In accordance with embodiments disclosed herein, the transaction engine 401 of each client 105 comprises a function 403 which derives verification values from data values and a signature of a party providing the transaction based on the derived verification value.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to select a set of data items, or data values derived therefrom, for which verification is required. Alice may also be able to select one or more worker to send proof transaction templates to, for verifying the data.

Alternatively or additionally, the UI elements may comprise one or more data entry fields 502, through which the user can enter identifiers of data items and/or workers for receiving the proof transaction templates. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 5. Node Software

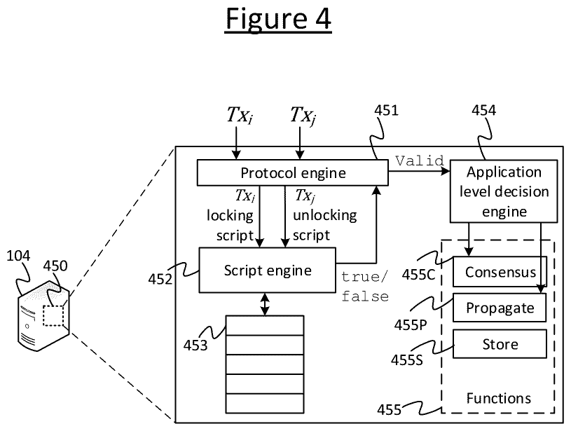

FIG. 4 illustrates an example of the node software 450 that is run on each blockchain node 104 of the network 106, in the example of a UTXO-or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 6. Signature Schemes

### 6.1 Elliptical Curve Digital Signature Algorithm (ECDSA)

The ECDSA scheme is used to create and verify digital signatures using elliptic curves. In this section, we briefly describe the processes of generating a digital signature and verifying it based on the ECDSA scheme. Digital signatures are used to prove the ownership of the UTXOs.

To generation a signature, a private key V is required to prove the identity. A corresponding public key PK is calculated by:

$$PK = V \cdot G ,$$

where ‘.’ denotes elliptic curve scalar multiplication, G is the elliptic curve generator point.

Now, given the private key V, a signature can be generated on a message m using the ECDSA scheme in the follow way:
1. Double hash the message m using the SHA-256 hash function:

$$e = SHA - 256 ( SHA - 256 ( m ) ) .$$

2. Randomly choose an integer k∈{1, 2, . . . , n−1} as an ephemeral private key.
3. Calculate the corresponding ephemeral public key R=k·G=(x, y).
4. Take the x-coordinate of the calculated point R:

r=[R]ₓ,

where [R]ₓ denotes the process of taking the x coordinate of an elliptic curve point. Note that if r=0, the signature will be independent of V, so return to step 2 and choose another k.
5. Calculate the modular inverse k⁻¹ of k mod n, where n is some prime modulus.
6. Calculate s=k⁻¹(e+Vr) mod n. If s=0, return to step 2 and choose another k. s≠0 is to ensure that signature verification is possible, as its inverse is required.
7. The signature is then given by (r, s).

The same message m can have different signatures since k is an ephemeral key and different for each case.

Given the message m, the public key PK and the signature (r, s), we could verify the signature using the following calculating:

$${R}^{′} = SHA - 256 ( SHA - 256 ( m ) ) {s}^{- 1} \cdot G + {rs}^{- 1} \cdot PK .$$

If [R′]ₓ=r, then the signature is valid, otherwise it is invalid.

### 7. Blockchain Spirits

### 7.1 Knowledge Proof

An “R-puzzle” is a type of transaction script that allows the spending party to sign the input UTXO using any valid public-private keypair. The key pair can be application-specific or randomly generated for one-off use.

In such a knowledge proof, the signer derives the r-part of the signature (r, s) using a secret number k.

An example locking script that uses an R-puzzle can have the following form:

OP_OVEROP3OP_SPLITOP_NIPOP_1OP_SPLITOP_SWAPOP_SPLITOP_DROPOP_HASH160<HASH(r)>OP_EQUALVERIFYOP_CHECKSIG

It will be appreciated that any opcode that performs hashing would be used instead of OP_HASH160, for example, OP_RIPEMD160, OP_SHA1, OP_SHA256, or OP_Hash256.

For brevity, the locking script can be represented as:

OP_OVER[Extract_r]OP_HASH160<HASH(r)>OP_EQUALVERIFYOP_CHECKSIG

where Extract_r is an abbreviation for a collection of op-codes that extracts the r from the signature. Extract_r is given by:

OP3OP_SPLITOP_NIPOP_1OP_SPLITOP_SWAPOP_SPLITOP_DROP

The above script drops the first 3 bytes of the signature, then extracts the r part of the signature, then drops the rest of the signature.

The unlocking script has the following form:

<Sig><PK>

where the signature takes the form (r,s), r being derived from the secret number k, and <PK> is the public key of the signer.

The signer, who provides the unlocking script, should know r such that kG=(x, y) and r=x mod n, i.e., the signer knows k which when multiplied by G produces a point whose x-coordinates is r when taken modulus n.

<Hash(r)> is provided in the locking script and therefore is public. The secret is k. The script execution is in the following table.

| Main Stack | Script |
|---|---|
| | <Sig><PK>OP_OVER [Extract_r] OP_HASH160 |
| | <HASH(r)> OP_EQUALVERIFY OP_CHECKSIG |
| <Sig><PK> | OP_OVER [Extract_r] OP_HASH160 <HASH(r)> |
| | OP_EQUALVERIFY OP_CHECKSIG |
| <Sig><PK><Sig> | [Extract_r] OP_HASH160 <HASH(r)> |
| | OP_EQUALVERIFY OP_CHECKSIG |
| <Sig><PK><r_{extracted}> | OP_HASH160 <HASH(r)> OP_EQUALVERIFY |
| | OP_CHECKSIG |
| <Sig><PK><Hash(r_{extracted})> | <HASH(r)> OP_EQUALVERIFY OP_CHECKSIG |
| <Sig><PK><Hash(r_{extracted})> | OP_EQUALVERIFY OP_CHECKSIG |
| <HASH(r)> | |

We pass to the following stage if the hash of the
extracted r equals the value in the L.S.

| | |
|---|---|
| <Sig><PK> | OP_CHECKSIG |

<True if correct message is signed with the secret
key that corresponds to the public key>

The signer can use any private-public key pair to sign the message. This is because neither the private key nor the corresponding public key is used in creating the locking script.

Therefore, the party providing the locking script does not need to know who will provide the unlocking script at the time of generating the transaction.

A pay-to-R-Puzzle can also be represented as P2RP HASH(r).

### 7.2 Pay to Public Key Hash (P2PKH)

A P2PKH transaction is a common type of payment transaction where the output of the transaction is to pay, or transfer an amount of digital asset, to a particular hash of a public key (also known as an address). To use this UTXO as an input in another transaction, an unlocking script with a public key PK and a valid corresponding ECDSA signature must be provided.

The ScriptPubKey and ScriptSig for a P2PKH transaction is shown below:

scriptPubKey: OP_DUP OP_HASH160<H(PK)>OP_EQUALVERIFYOP_CHECKSIG

scriptSig: <sig><PK>

### 7.3 Pay to R-Puzzle Hash (P2RPH)

A P2RPH transaction is a transaction that pays to a R-puzzle challenge. To spend the input UTXO, an unlocking script with a signature that contains the same r used for the R-puzzle challenge needs to be provided.

The ScriptPubKey and ScriptSig for a P2RPH transaction is shown below:

scriptPubKey: OP_DUPOP_3OP_SPLITOP_NIPOP_1OP_SPLITOP_SWAPOP_SPLIT OP_DROPOP_HASH160(H(r))OP_EQUALVERIFYOP_SWAPOP_CHECKSIG

scriptSig: <sig′><PK><sigr>

The signature sigr uses r and the spender can calculate the signature using any private/public keypair. The signature sig′ is generated with another signed message (different from the one used in the signature sigᵣ), and this could be done by using a different sighash flag. Note that the signature sig′ must use a different value of r so that it does not leak the private key.

The signature sig′ is added to the scriptSig to avoid the signature forgeability. Without the signature sig′, a malicious actor could intercept the P2RPH transaction and then change the transaction to send the funds to himself while using the same signature that the transaction sender used in the original transaction.

### 7.4 Scripts with Conditional Clauses

Conditional clauses can be implemented in locking scripts using the OP_IF statements. OP_IF will execute the set of subsequent opcodes up-to the following OP_ELSE or OP_ENDIF if the value on top of the stack is true, or non-zero. If an OP_ELSE is the subsequent conditional clause and the first conditional clause was successful, the script will jump forward to the OP_ENDIF at the conditional-stack height of the original clause. Once the OP_ENDIF is processed, then the script execution will end and return the result.

### 8. Conditional Payment Protocol

A payment protocol is described herein in the context of an example use case in which a worker verifies data stored to third-party platforms.

In the example use case, a user has stored data to a third-party cloud platform. The user entrusts the cloud service provider in properly storing and maintaining their data. If the user requires assurance of integrity of stored data, then they themselves can check the data periodically. Doing this, users need to download the entirety of the data of interest in order to verify its integrity.

However, users are often resource-constrained and unable to complete the integrity verifications in a timely manner, whereas there may exist third party workers that may be willing to be outsourced service providers for completing tasks as they are willing to spend computing resources for these verifications. Thus, users can outsource computations to these workers. However, concerns arise in outsourcing computations where a user (outsourcer) may not trust workers to correctly perform computations and, likewise, workers do not trust a user to pay for completed jobs.

The protocol described herein can be used to set up payment rules for outsourced computations. The outsourced computations may comprise retrieving data from the cloud and/or any other databases and verifying the integrity of data saved off-chain. An outsourcer, say Alice 103a, can outsource computations via submitting a task transaction to the blockchain, and specify the payment amounts for different computation results via a series of proof of computation transactions.

Any worker(s), say Bob(s) 103b, can claim the task and then start the computations. Alice 103a and Bob(s) 103b have the public keys which are used to construct a secure communication channel based on a cryptography-based secret sharing scheme. Templates of the proof of computation transactions are created by Alice 103a and sent from Alice 103a to Bob(s) 103b via the channel. When the computations are finished, Bob 103b may reveal the results through one of the given templates of proof of computation transactions, and then broadcast that transaction to the blockchain network to get paid.

If the metadata stored at the cloud platform is modified by some malicious actors, workers may not be able to produce the correct results. Note that the metadata may be obtained by the workers in any suitable way. For example, the workers may access the metadata directly from the cloud platform. In such a scenario, the task will not be claimed by any workers, that is no valid proof transaction is provided and thus a task reward is not claimed. Alice 103a may investigate the reasons for this by communicating with the workers and can determine if the metadata has been tampered with. Then, assuming the existence of an agreement between the parties, Alice 103a may pay some compensation to the workers who had accepted the task.

In the examples set out below, it is assumed that the metadata is not tampered with, and the correct calculation results will be obtained if the workers work properly.

The protocol has the following features:
Transparency—the payment amounts are transparent for all the workers.
Competitive—the workers need to work best in competition to get paid for the results. The UTXO of the task transaction can only be spent once by one worker. The competition is beneficial to Alice 103a for not only obtaining the results as quickly as possible but also not relying on only one worker. Relying on one worker may increase the risk that the task will not be completed if the worker did not work correctly.
Sequential—the payment amounts on the proof of computation transactions are locked in sequence, the better the computation result revealed, the more rewards are obtained. A locking script is designed to accommodate this, otherwise the payments are not assigned correctly.

In the following sections, the details of the task transaction and the proof of computation, or proof, transactions. For simplicity, the transaction fees are ignored in these transactions, but they can be included without disruption to the logic, as will be apparent to the person skilled in the art.

### 8.1 Metadata and Revealed Result

Metadata is used herein to refer to the encrypted data that Alice 103a would like workers to verify. For instance, Alice's Monday documents saved on the Cloud are encrypted and represented as k₀, and Tuesday documents are encrypted and represented as k₁ and so on. The documents are encrypted in order to ensure privacy of the stored data for Alice 103a.

The revealed result r is data that workers will reveal on the blockchain to prove the knowledge of metadata k. The revealed result r may be the concatenation of various metadata k.

Suppose kᵢ is i^{th} metadata that Alice 103a wishes to verify, and rᵢ is the revealed result that workers will reveal on the blockchain, where i=0,1,2, . . . , n, then:

$${r}_{0} = {k}_{0} ,$$

$${r}_{1} = {k}_{0} \vert \vert {k}_{1} ,$$

$${r}_{2} = {k}_{0} ‖ {k}_{1} ‖ {k}_{2} ,$$

$$⋮$$

$${r}_{i} = {k}_{0} ‖ {k}_{1} ‖ {k}_{2} ‖ … ‖ {k}_{i} .$$

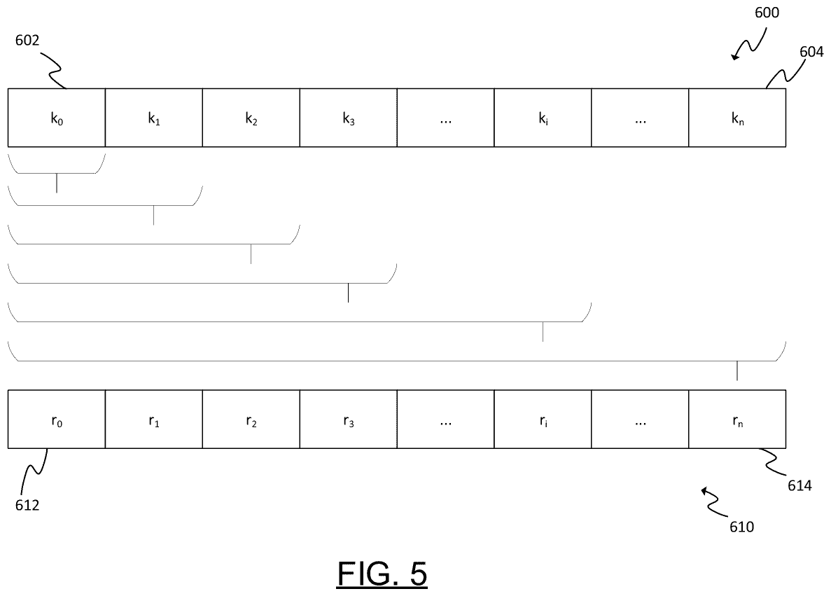

The relationship between metadata k and the revealed data r is shown in FIG. 5.

A sequence of data values, or metadata, k 600 is shown, comprising a first data value k₀ 602, one or more intermediate data values, and a last data value kₙ 604. A sequence of verification values 610 is derived from the sequence of data values 600. A first verification value r₀ 612 is derived from the first data value k, 602, a second verification value r₁ is derived from k₀ and k₁, and so on, such that a final verification value rₙ 614 is derived from all of the data values of the sequence of data values 600.

In the example described herein, the data values are concatenated in sequence to derive the verification values. However, it will be apparent to the person skilled in the art that the data values may be combined in other ways. For example, the data values may be summed or multiplied in sequence to derive the verification values.

The data values k are said to be derived from data items, the data items in this example being the documents stored to the cloud.

### 8.2 Task Transaction

The task transaction is created by Alice 103a to outsource computations on the blockchain network and specify rewards for these calculations. The rewards can be able to be claimed by any workers who can reveal the results of these calculations. Any unspent UTXO controlled by Alice 103a can be used as an input in the task transaction. A representation of the task transaction is shown below.

TxIDₜₐₛₖ

| version | 1 | Locktime | 0 |
|---|---|---|---|
| Inputs | | Outputs | |
| Any | | b | OP_DUP OP_HASH160 H(r₀) OP_EQUALVERIFY |
| unspent | | | OP_IF |
| UTXO | | | OP_DROP OP_DUP OP_HASH160 <H(PK_{A}_{₀})> |
| | | | OP_EQUALVERIFY OP_CHECKSIG |
| | | | OP_ELSE |
| | | | OP_DUP OP_HASH160 H(r₁) OP_EQUALVERIFY |
| | | | OP_IF |
| | | | OP_DROP OP_DUP OP_HASH160 <H(PK_{A}_{₁})> |
| | | | OP_EQUALVERIFY OP_CHECKSIG |
| | | | OP_ELSE |
| | | | OP_DUP OP_HASH160 H(r₂) OP_EQUALVERIFY |
| | | | OP_IF |
| | | | ...... |
| | | | OP_ELSE |
| | | | OP_DUP OP_HASH160 H(rᵢ) OP EQUALVERIFY |
| | | | OP_IF |
| | | | OP_DROP OP_DUP OP_HASH160 <H(PK_{A}_{₁})> |
| | | | OP_EQUALVERIFY OP_CHECKSIG |
| | | | OP_ELSE |
| | | | OP_FALSE |
| | | | OP_ENDIF |
| | | | ...... |
| | | | OP_ENDIF |
| | | | OP_ENDIF |
| | | | OP_ENDIF |
| | | 0 | OP_FALSE OP_RETURN <Data> |

Conditional clauses are used in the locking script to specify the desired computation results. The parameters in the output are described below.
b is the maximum payment amount to be assigned to the calculation results.
PK_{A}_{ᵢ} is i^{th} public key controlled by Alice 103a and is assigned to the revealed result rᵢ. When using this UTXO as an input to another transaction, that transaction would have to provide an unlocking script with a valid ECDSA signature using PK_{A}_{ᵢ}. This public key is helpful for Alice 103a to take control of the payment rules to different results.
Data in the OP_RETURN output contains:
   a timestamp indicating when Alice 103a will send the information to the workers; and
   a Merkle root of all generated templates of proof of computation transactions. This is useful for Alice 103a to prove the transparency of her payment rules.

The payload data is to ensure that each worker can verify the fairness of whether he/she obtains the same payment rules from Alice at the same time. In fact, Alice 103a has no incentive to send the information synchronously because she does not know which worker can complete the task faster than others if the information is given to him or her in advance.

As shown above, the locking script comprises multiple different unlocking conditions, each defined in a separate subscript of the locking script.

The first subscript of the locking script defines the unlocking condition which is satisfied if the worker provides the first verification value r₀. In this subscript, Alice's public key is based on r₀.

If the unlocking condition of the first subscript is not satisfied, the second subscript is executed, which is satisfied if the worker provides a second verification value r₁. In this subscript, Alice's public key is based on r₁.

This pattern is continued, with each next subscript having an unlocking condition which is satisfied by a next verification value in the sequence of verification values. The worker providing the verification value is thus rewarded for the amount of computation work they have done.

The subscript conditions are satisfied if the worker provides the verification value r in the unlocking script, as described below. The locking script can therefore be said to correspond to a hash puzzle, a type of knowledge puzzle.

### 8.3 Proof of Computation Transactions (PCTXs)

A proof of computation transaction, or proof transaction, is a transaction that allows workers to automatically be paid for producing the correct calculation results and broadcasting these results to the blockchain network.

Alice 103a generates a proof transaction template corresponding to each of the set of verification values. The proof transaction template comprises a template unlocking script which comprises a signature and a public key provided by Alice 103a and which, when provided together with the verification value or a value derived therefrom, forms an unlocking script for unlocking one of the subscripts of the locking script.

All n templates of proof of computation transactions are created by Alice 103a to specify the payment amount for the corresponding results (r values). These template transactions are not broadcast. For the different r values presented in the task transaction, the payment amount assigned to the proof of computation transactions vary. Considering a case of no change (e.g., the maximum amount b is paid to a worker who reveals rₙ), a signhash_NONE flag is used in the n^{th} TxIDₙ (template) shown below to sign the input and no output. This allows Bob 103b to add his output to receive the maximum payment b, as can be seen in the published proof transaction TxIDₙ.

TxIDₙ (template)

| version | 1 | | Locktime | T₁ |
|---|---|---|---|---|
| In-count | 1 | | Out- | 1 |
| | | | count | |
| Inputs | | | Outputs | |
| | | Sequence | | Locking |
| Outpoint | Unlocking script | Number | Value | script |
| TxIDₜₐₛₖ∥0 | < sig_{A}_{ₙ}NONE > | 0xFFFFFFFF | | |
| | < PK_{A}_{ₙ} > | | | |

TxIDₙ

| version | 1 | | Locktime | T₁ |
|---|---|---|---|---|
| In-count | 1 | | Out- | 1 |
| | | | count | |
| Inputs | | | Outputs | |
| | | Sequence | | Locking |
| Outpoint | Unlocking script | Number | Value | script |
| TxIDₜₐₛₖ∥0 | < sig_{A}_{ₙ}NONE > | 0xFFFFFFFF | b | <P2PKH |
| | < PK_{A}_{ₙ} >< rₙ > | | | PK_{B}> |

In the above example, the worker provides the final verification value rₙ. Since rₙ is derived from all of the data values, the worker must have performed computations for all data values of the sequence of data values and therefore is to be rewarded with the whole available reward b.

A template of proof of computation transaction TxIDᵢ (template) is shown below for i≠n. This template is different from TxIDₙ (template) shown above. A sighash_SINGLE flag is used in TxIDᵢ (template) to sign the input and the output with the same index. This flag allows Alice to add her output to receive the change (b−bᵢ). Any change to her output will cause the validation of TxIDᵢ to fail. The worker is rewarded with bᵢ.

TxIDᵢ (template)

| version | 1 | | Locktime | T₁ |
|---|---|---|---|---|
| In-count | 1 | | Out- | 1 |
| | | | count | |
| Inputs | | | Outputs | |
| | | Sequence | | Locking |
| Outpoint | Unlocking script | Number | Value | script |
| TxIDₜₐₛₖ∥0 | < sig_{A}_{ₙ}SINGLE > | 0xFFFFFFFF | (b − bᵢ) | <P2PKH |
| | < PK_{A}_{ᵢ} > | | | PK_{A}> |

TxIDᵢ

| version | 1 | | Locktime | T₁ |
|---|---|---|---|---|
| In-count | 1 | | Out- | 2 |
| | | | count | |
| Inputs | | | Outputs | |
| | | Sequence | | Locking |
| Outpoint | Unlocking script | Number | Value | script |
| TxIDₜₐₛₖ∥0 | < sig_{A}_{ₙ}SINGLE > | 0xFFFFFFFF | (b − bᵢ) | <P2PKH |
| | < PK_{A}_{ᵢ} ><rᵢ > | | | PK_{A}> |
| | | | bᵢ | <P2PKH |
| | | | | PK_{B}> |

The features of PCTXs are as follows:
The same outpoint TxIDₜₐₛₖ∥0 is used as an input to all PCTXs (TxID₀, TxID₁, . . . , TxIDₙ).
T₁ is the freezing time of funds and indicates that a proof of computation transaction is valid to be redeemed after T₁. This means that no one can spend the output b until at least time T₁.
The sequence number for all PCTXs is set to maximum integer value (0xFFFFFFFF).
Only one PCTX will be seen on the blockchain network when it is redeemed (a UTXO can only be spent once).
The public key PK_{A}_{ᵢ} varies for each transaction TxIDᵢ. The entire string (locking script of the task transaction+unlocking script of the proof of computation transaction) is evaluated by the miner, which checks that the correct public key PK_{A}_{ᵢ} is provided.
sig_{A}_{ₙ} is Alice's signature from the public key PK_{A}_{ₙ}. A sighash flag SIGHASH_NONE is added to sig_{A}_{ₙ} and this allows for Bob 103b to add his output in the TxIDₙ so that no changes will be returned to Alice 103a.
sig_{A}_{ᵢ} is Alice's signature from the public key PK_{A}_{ᵢ} and i≠n.
   A sighash flag SIGHASH_SINGLE is added to sig_{A}_{ᵢ} to sign the output paying (b−bᵢ) BSV. This output shares the same index as the signature. If that output is modified by Bob 103b, the signature sig_{A}_{ᵢ} becomes invalidated. In this case, Bob 103b could not get paid. This is useful for Alice 103a to take control of the amount of change returned to her, in other words, Alice 103a can assign different payment amounts to different r values.
   The nLocktime T₁ is embedded into the signed message. If it is modified by Bob 103b, then the signature sig_{A}_{ᵢ} becomes invalidated.
The public key PK_{A}, controlled by Alice 103a, is the same for each proof of computation transaction and is used to receive change.
(b−bᵢ) BSV is the change to Alice 103a.
bᵢ is the payment amount that Alice assigns to rᵢ·b₀, b₁, . . . , bᵢ is an increasing sequence such as an increasing linear sequence bᵢ=a*i+d, where a is a common difference, d is a positive constant and i=0,1,2,3, . . . , n, but bₙ≤b. For example, b₀, b₁, . . . , b₅ if a=1, d=1, then b₀=1, b₁=2, b₂=3, b₃=4, b₄=5 and b₅=6. That is, the maximum amount b should be greater than or equal to b₅. Note that a and b are the parameters set by Alice 103a to satisfy her payment rules, but the workers do not need to know them.

After receiving the template proof of computation transactions, Bob 103b starts the calculations and obtains rᵢ. Then, Bob 103b puts rᵢ, or a value derived therefrom, in the unlocking script, and his public key PK_{B} in the locking script for receiving the payment. He broadcasts the TxIDᵢ (see examples aboveError! Reference source not found.) to the blockchain network to claim bᵢ sats.

In the above examples, Alice 103a sets the same nLocktime and the same sequence number (maximum value 0xFFFFFFFF) for all of the proof transaction templates. The same sequence number (maximum value) indicates that this is the ‘final’ version of the transaction, and it cannot be overruled. If they all have UNIT_MAX (0xFFFFFFFF) sequence numbers, then when the nLocktime arrives, the first transaction to be seen by a miner is chosen to be verified and publish on the blockchain. This may cause unfair remuneration for better-performing workers. For instance, if Bob 103b does a small amount of calculations (e.g. to find r₁) and Charlie completes the full calculation (to find rₙ), it would be easy for Bob 103b to send his transaction to the network first as he only did a quick bit of work. Charlie does all the work and submits his proof transaction Tx later (but still in the same block window of time). Here, a block window of time means the time gap between two blocks, such as 10-min average block confirmation time. The sent transactions from Bob 103b and Charlie have the same input UTXO, meaning that only one of gets included in a block; it will be Bob's transaction once the nLocktime is reached because he had been the first to submit. Charlie's transaction will be rejected.

Because of this, despite their potential to calculate further rᵢ values, workers may elect not to pursue these additional computations for fear that they may be beat to transaction submission. Alice 103a would then not obtain the best results.

To mitigate against this, the different sequence numbers can be used when Alice 103a signs each PCTX template. This is done in a way that allows more advanced computations to be chosen automatically by the miners over a more basic one, because the advanced computation PCTX has a higher sequence number. That is, the proof transaction template for the first verification value r₀ has the lowest sequence number, each successive verification value in the sequence of verification values is associated with an increasingly high sequence number, with the proof transaction template for the final verification value rₙ having the highest sequence number.

Alice 103a keeps the same nLocktime for all of the transaction templates. That means, none of the transactions will be published before this nLocktime no matter what their sequence numbers are. If the nLocktime arrives and there are many transactions with different sequence numbers, then the one with the largest value is chosen by the miner. But either way the nLocktime is adhered to, and no transactions can be published before that time. For instance, Alice 103a can set the highest sequence number UNIT_MAX (0xFFFFFFFF) for TxIDₙ₋₁, the second highest UNIT_MAX−1 for TxIDₙ₋₂ and so on. The lowest sequence number such as 0 is set for TxID₀. This ensures that the most difficult calculation is rewarded.

The sequence number is included in the signed message for the corresponding signature of each transaction template (e.g., sig_{A}_{ᵢ} SINGLE (i≠n) and sig_{A}_{ₙ} NONE). The signature verification will fail if workers modify the sequence number after Alice 103a has signed the proof transaction template.

### 8.4 Two-Layer PCTXs

As we mentioned above, only one proof of computation transaction is published on the blockchain network. If the published transaction is not TxIDₙ that reveals the longest concatenation rₙ result, that means some metadata (e.g., kₙ₋₁, kₙ) have not been verified.

To solve this problem, a hierarchical structure of the two-layer, or multi-layer, PCTXs is provided. The first layer PCTXs are defined as transactions that spends the task transaction as shown above, and the second layer PCTXs are transactions that spend Alice's change of the published first-layer proof of computation transaction. For example, if the worker determines the verification value r₁, such that the worker is rewarded with b₁, Alice's change is (b−b₁), which she can provide as a reward in the second layer PCTXs.

The second layer PCTXs can stimulate workers to verify the remaining k values and then reveal them with the corresponding r value.

Suppose TxIDᵢ (i+n) is published, and Alice 103a creates a second layer PCTXs: TxID_{i,j}, TxID_{i,j+1}, . . . , TxID_{i,n} (0≤j≤n−i), where the first subscript i indicates that all of the second layer PCTXs will use the outpoint TxIDᵢ∥0 (the change output of TxIDᵢ) as the input, and the second subscript j stands for the number of r values that are possible to be revealed. Now, workers who lose the chance to get the payment in the first layer PCTXs can have opportunity to get paid from the second layer PCTXs.

Note that, in this context, the locking script of Alice's change output in the template of the first layer PCTXs TxID₀, TxID₁, . . . , TxIDₙ shown above is modified. If Alice 1030 sets up three r values: r₀, r₁, r₂ in the task transaction TxIDₜₐₛₖ, the locking script for the transaction TxID₀ (template), that is the proof transaction template corresponding to r₀, would be:

```
OP_DUP OP_HASH160 H(r₁) OP_EQUALVERIFY
OP_IF
  OP_DROP OP_DUP OP_HASH160 <H(PK_{A}_{₁})> OP_EQUALVERIFY
OP_CHECKSIG
OP_ELSE
  OP_DUP OP_HASH160 H(r₂) OP_EQUALVERIFY
  OP_IF
    OP_DROP OP_DUP OP_HASH160 <H(PK_{A}_{₂})> OP_EQUALVERIFY
OP_CHECKSIG
  OP_ELSE
    OP_FALSE
  OP_ENDIF
OP_ENDIF
```

such that the worker is rewarded for providing either r₁ or r₂ in a subsequent proof transaction.

The locking script for TxID₁ (template) that is the proof transaction template corresponding to r₁, would be:

```
OP_DUP OP_HASH160 H(r₂) OP_EQUALVERIFY
OP_IF
  OP_DROP OP_DUP_OP_HASH160 <H(PK_{A}_{₂})> OP_EQUALVERIFY
OP_CHECKSIG
OP_ELSE
  OP_FALSE
OP_ENDIF
```

such that the worker is rewarded for providing r₂ in a subsequent proof transaction.

The locking script for TxID₂ (template) would be:

OP_DUPOP_HASH160<H(PK_{A})>OPEQUALVERIFYOP_CHECKSIG

since the worker has already completed all the task computations. It will be appreciated that the locking script of TxID₂ (template) is optional since r₂ is the final verification value and thus it is possible that no change will be refunded to Alice 103a.

If TxID₀ is published on the blockchain network, then the templates of the second layer PCTXs TxID₀₀ and TxID₀₁ will be created by Alice 103a, shown below. TxID₀ could be considered as a task transaction like TxIDₜₐₛₖ, but without an OP_FALSE OP_RETURN output. Alice 103a does not know which PCTX will be published, so it is time consuming and costly to generate the templates of the second layer PCTXs and include a Merkle root of all generated templates in the OP_FALSE OP_RETURN output of the first layer TxIDᵢ. However, in order to maintain the task's transparency described above, Alice 103a can add the similar information (e.g., a timestamp and a Merkle root of all generated second layer templates of PCTXs) to the OP_FALSE OP_RETURN output of the second layer PCTXs when she creates the templates.

TxID₀₀ (template)

| version | 1 | | Locktime | T₁ |
|---|---|---|---|---|
| In-count | 1 | | Out- | 2 |
| | | | count | |
| Inputs | | | Outputs | |
| | | Sequence | | Locking |
| Outpoint | Unlocking script | Number | Value | script |
| TxID₀∥0 | <sig_{A}_{₁} SINGLE> | 0xFFFFFFFE | (b − b₀) − | OP_DUP OP_HASH160 H(r₂) |
| | < PK_{A}_{₁} > | | b₀₀) | OP_EQUALVERIFY |
| | | | | OP_IF |
| | | | | OP_DUP OP_HASH160 |
| | | | | <H(PK_{A}_{₂})> OP_EQUALVERIFY |
| | | | | OP_CHECKSIG |
| | | | | OP_ELSE |
| | | | | OP_FALSE |
| | | | | OP_ENDIF |
| | | | 0 | OP_FALSE OP_RETURN |
| | | | | < Data > |

TxID₀₁ (template)

| version | 1 | | Locktime | T₁ |
|---|---|---|---|---|
| In-count | 1 | | Out- | 2 |
| | | | count | |
| Inputs | | | Outputs | |
| | | Sequence | | Locking |
| Outpoint | Unlocking script | Number | Value | script |
| TxIDₜₐₛₖ∥0 | < sig_{A}_{₂} NONE > | 0xFFFFFFFF | | |
| | < PK_{A}_{₂} > | | | |
| | | | 0 | OP_FALSE OP_RETURN |
| | | | | < Data > |

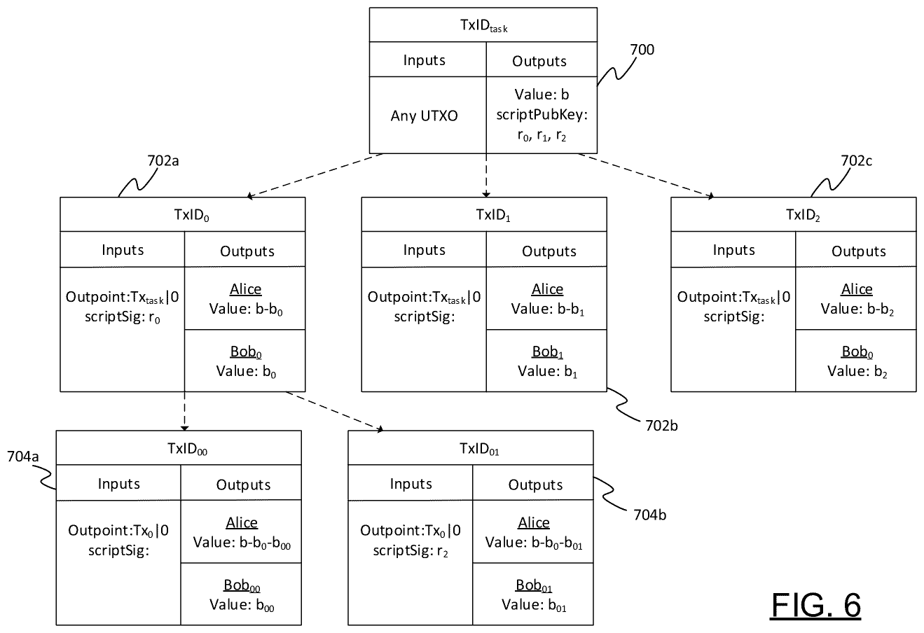

FIG. 6 illustrates a hierarchical structure of two-layer proof of computation transactions for the example above in which three verification values are defined.

The task transaction 700 comprises an input referencing any UTXO of Alice's The value of the UTXO is at least b. The output of the task transaction 700 comprises the reward value b which is awarded to a worker if they find the final verification value r₂ and a locking script comprising subscripts for each of r₀, r₁, and r₂.

A worker is rewarded if they provide one of the first layer proof transactions 702a, 702b, 702c. If the worker derives r₀, they generate the proof transaction TxID₀ 702a from the proof transaction template with the template unlocking script for satisfying the unlocking condition in the task transaction 700 corresponding to r₀. If the worker derives r₁, they generate the proof transaction TxID₁ 702b from the proof transaction template with the template unlocking script for satisfying the unlocking condition in the task transaction 700 corresponding to r₁. If the worker derives r₂, they generate the proof transaction TxID₂ 702c from the proof transaction template with the template unlocking script for satisfying the unlocking condition in the task transaction 700 corresponding to r₂.

Each of the first layer proof transactions 702a, 702b, 702c comprises an input and an output. Each input comprises an outpoint pointing to the output of the task transaction 700 at which the locking script is located, as well as an unlocking scrip comprising a signature based on the derived verification value. Each output defines a payment amount, or value of digital asset, to be transferred back to Alice 103a, and a value of digital asset to be transferred to the worker (Bob 103b) in return for completing the computation.

Two second layer proof transactions 704a, 704b are shown in FIG. 6. These can be provided if the worker initially only derives r₀. It will be appreciated that a second layer proof transaction may be provided if instead the worker initially derived r₁. This second layer proof transaction is not shown in FIG. 6.

Each of the second layer proof transactions 704a, 704b shown in FIG. 6 have an outpoint pointing to the output of TxID₀ 702a comprising the locking script.

A first of the second layer proof transactions TxID₀₀ 704a satisfies an unlocking condition of the first layer proof transaction TxID₀ 702a, that is the unlocking script of TxID₀₀ 704a is generated using r₁ such that the input comprises a signature based on r₁.

A second of the second layer proof transactions TxID₀₁ 704b satisfies a different unlocking condition of the first layer proof transaction TxID, 702a, that is the unlocking script of TxID₀₁ is derived from r₂ such that the input comprises a signature based on r₂.

Each of the second layer proof transactions 704a, 704b shown in FIG. 6 have outputs defining values assigned to Alice 103a and Bob 103b. The amount assigned to Alice 103a is the amount assigned to Alice 103a in TxID₀ less the amount assigned to Bob 103b in the second layer proof transactions 704a, 704b.

The proof transactions TxID₂ and TxID₀₁ corresponding to the final verification value r₂ may be modified such that Alice 103a does not receive any value, that is there is no output associated with Alice 103a.

The r value shown in each proof of computation transaction 702a, 702b, 702c, 704a, 704b only indicates that it may be revealed in the corresponding spending transaction. It is only when one of the proof of computation transactions 702a, 702b, 702c, 704a, 704b like TxID₀ is published on the blockchain network that the r₀ is revealed, shown in the unlocking script.

Additionally, the second layer of proof of computation transactions 704a, 704b (TxID₀₀ and TxID₀₁) use TxID₀|0 as the input, when the TxID₀ was published on the Bitcoin network.

The transaction TxID₀₀ 704a is used to reveal r₁ to get paid b₀₀, and TxID₀₁ 704b is to reveal r₂. As shown in Error! Reference source not found, if the TxID₀₁ 704b is broadcast to the blockchain network, that means the knowledge proof of all the required metadata k is provided, thus no more layers of proof of computation transactions are needed. However, if needed, the downstream of the second layer PCTXs could be extended by following the similar principle.

According to the design of the PCTXs described above, the r value is revealed in the unlocking script. If a proof of computation transaction such as TxID₀₁ 704b is intercepted by a malicious actor in the channel between Bob 103b and a blockchain node, this malicious actor can obtain the funds by the revealed r₂. He can keep r₂ but replace Bob's public key with his own public key to receive the payment, and then propagate the modified transaction to the blockchain network. In this case, Bob 103b could not get paid, and Alice 103a would not know her payment had been claimed by a malicious actor rather than Bob 103b.

A possible solution to this security concern is to use an R-puzzle in the transactions (both the task transaction and the proof of computation transactions). An R-puzzle is a type of knowledge puzzle.

In an R-puzzle implementation, the worker generates an ECDSA signature using r to unlock the digital asset locked by Alice 103a. Suppose Alice 103a wishes to verify the integrity of metadata k. There are two main parts in an ECDSA signature, r and s as set out above. r is the result that Bob 103b needs to reveal, and k is the value that Bob 103b needs to verify. If using private/ephemeral keys that are 256 bits long in the ECDSA signature, then the revealed result r and the metadata k are related in the following way:

$$r = {[ SHA - 256 ( k ) \cdot G ]}_{x} ,$$

where ‘·’ denotes elliptic curve scalar multiplication, G is the elliptic curve generator point and [ ]ₓ denotes taking the x coordinate of an elliptic curve point, SHA-256 is a cryptographic hash function, and SHA-256(k) is considered as the ephemeral private key in the ECDSA signature. Note that the worker Bob 103b could compute a signature sigᵣ=(r, s) using any private/public key pair controlled by him.

For simplicity, we only consider three r values as in the example of FIG. 6, and three 256-bit hash values mapped from the metadata are k₀, k₁, k₂, then:

$${r}_{0} = {[ SHA - 256 ( {k}_{0} ) \cdot G ]}_{x} ,$$

$${r}_{1} = {[ SHA - 256 ( {k}_{0} \vert \vert {k}_{1} ) \cdot G ]}_{x} ,$$

$${r}_{2} = {[ SHA - 256 ( {k}_{0} \vert \vert {k}_{1} \vert \vert {k}_{2} ) \cdot G ]}_{x} .$$

In the above equation of computing r₁, the concatenated k₀∥k₁ is hashed and the hash value used as the ephemeral key to generate the sigᵣ_{₁} over r₁. Note that any other ways of linking r and k could be decided by Alice 103a according to her needs, but she needs to tell the workers the way. Based on the knowledge of R-puzzle, the locking script in the task transaction looks like:

```
OP_DUP OP_3 OP_SPLIT OP_NIP OP_1 OP_SPLIT OP_SWAP OP_SPLIT
OP_DROP
OP_DUP OP_HASH160 H(r₀) OP_EQUALVERIFY
OP_IF
          OP_DROP OP_2SWAP OP_DUP OP_HASH160 <H(PK_{A}_{₀})>
        OP_EQUALVERIFY OP_CHECKSIG
          OP_OVER OP_CHECKSIGVERIFY OP_CHECKSIG
OP_ELSE
          OP_DUP OP_HASH160 H(r₁) OP_EQUALVERIFY
          OP_IF
            OP_DROP OP_2SWAP OP_DUP OP_HASH160 <H(PK_{A}_{₁})>
        OP_EQUALVERIFY OP_CHECKSIG
            OP_OVER OP_CHECKSIGVERIFY OP_CHECKSIG
          OP_ELSE
            OP_DUP OP_HASH160 H(r₂) OP_EQUALVERIFY
            OP_IF
                OP_DROP OP_2SWAP OP_DUP OP_HASH160 <H(PK_{A}_{₁}₎>
        OP_EQUALVERIFY OP_CHECKSIG
                OP_OVER OP_CHECKSIGVERIFY OP_CHECKSIG
            OP_ELSE
              OP_FALSE
            OP_ENDIF
          OP_ENDIF
OP_ENDIF
```

In this case, if r₀ is revealed by a worker Bob₀ through publishing the proof of computation transaction TxID₀ on the blockchain network, and then the corresponding unlocking script of TxID₀ would be:

[symbol]

sig_{B}_{₀}NONE [symbol] [symbol] sig_{A}_{₀}SINGLE [symbol] [symbol] (PK_{A}_{₀} [symbol] [symbol] PK_{B}_{₀} [symbol] [symbol] sigᵣ_{₀}ALL

[symbol]

where a signature sigᵣ_{₀} over r₀ is generated from a public key PK_{B}_{₀} controlled by Bob₀, and sig_{B}_{₀} from PK_{B}_{₀} is another signature. sig_{B}_{₀} must be generated on a different signed message (for example using a different sighash flag SIGHASH_NONE instead of SIGHASH_ALL which is the flag used in the signed message of sigᵣ_{₀}, and a different ephemeral key so that it will not leak the private key associated with the public key PK_{B}_{₀}. This is a precaution as a private key can be derived from two EC signatures which use the same ephemeral key.

The table below shows the script execution steps when the locking script of the task transaction is run together with the unlocking script of the proof transaction when R-puzzles are used.

| Stack | script | description |
|---|---|---|
| empty | [symbol] sig_{B}_{₀} NONE [symbol] [symbol] sig_{A}_{₀} SINGLE [symbol] [symbol] PK_{A}_{₀} [symbol] [symbol] PK_{B}_{₀} [symbol] | scriptSig and |
| | [symbol] sigᵣ_{₀}ALL [symbol] | scriptPubKey are |
| | OP_DUP OP_3 OP_SPLIT OP_NIP OP_1 | combined |
| | OP_SPLIT OP_SWAP OP_SPLIT OP_DROP | |
| | OP_DUP OP_HASH160 H(r₀) | |
| | OP_EQUALVERIFY OP_IF OP_DROP | |
| | OP_2SWAP OP_DUP OP_HASH160 <H(PK_{A}_{₀})> | |
| | OP_EQUALVERIFY OP_CHECKSIG OP_OVER | |
| | OP_CHECKSIGVERIFY OP_CHECKSIG OP_ELSE | |
| | OP_DUP OP_HASH160 H(r₁) | |
| | OP_EQUALVERIFY OP_IF OP_DROP | |
| | OP_2SWAP OP_DUP OP_HASH160 | |
| | <H(PK_{A}_{₁})> OP_EQUALVERIFY OP_CHECKSIG | |
| | OP_OVER OP_CHECKSIGVERIFY | |
| | OP_CHECKSIG OP_ELSE OP_DUP | |
| | OP_HASH160 H(r₂) OP_EQUALVERIFY OP_IF | |
| | OP_DROP OP_2SWAP OP_DUP OP_HASH160 | |
| | <H(PKA₂)> OP_EQUALVERIFY OP_CHECKSIG | |
| | OP_OVER OP_CHECKSIGVERIFY | |
| | OP_CHECKSIG OP_ELSE OP_FALSE OP_ENDIF | |
| | OP_ENDIF OP_ENDIF | |
| [symbol] sig_{B}_{₀} NONE [symbol] | OP_HASH160 H(r₀) OP_EQUALVERIFY OP_IF | Duplicate signature |
| [symbol] sig_{A}_{₀} SINGLE [symbol] | OP_DROP OP_2SWAP OP_DUP OP_HASH160 | <sigᵣ_{₀}ALL>, extract r₀ |
| [symbol] PK_{A}_{₀} [symbol] [symbol] PK_{B}_{₀} [symbol] | <H(PK_{A}_{₀}) > OP_EQUALVERIFY OP_CHECKSIG | from duplicated |
| [symbol] sigᵣ_{₀} ALL [symbol] [symbol] r₀ [symbol] [symbol] r₀ [symbol] | OP_OVER OP_CHECKSIGVERIFY | signature <sigᵣ_{₀}ALL>, |
| | OP_CHECKSIG OP_ELSE OP_DUP | and duplicate r₀ |
| | OP_HASH160 H(r₁) OP_EQUALVERIFY OP_IF | |
| | OP_DROP OP_2SWAP OP_DUP OP_HASH160 | |
| | <H(PK_{A}_{₁})> OP_EQUALVERIFY OP_CHECKSIG | |
| | OP_OVER OP_CHECKSIGVERIFY | |
| | OP_CHECKSIG OP_ELSE OP_DUP | |
| | OP_HASH160 H(r₂) OP_EQUALVERIFY OP_IF | |
| | OP_DROP OP_2SWAP OP_DUP OP_HASH160 | |
| | <H(PK_{A}_{₂})> OP_EQUALVERIFY OP_CHECKSIG | |
| | OP_OVER OP_CHECKSIGVERIFY | |
| | OP_CHECKSIG OP_ELSE OP_FALSE OP_ENDIF | |
| | OP_ENDIF OP_ENDIF | |
| [symbol] sig_{B}_{₀} NONE [symbol] | OP_IF OP_DROP OP_2SWAP OP_DUP | Hash r₀ and check if |
| [symbol] sig_{A}_{₀} SINGLE [symbol] | OP_HASH160 <H(PK_{A}_{₀}) > OP_EQUALVERIFY | hashed r₀ = H(r₀) |
| [symbol] PK_{A}_{₀} [symbol] [symbol] PK_{B}_{₀} [symbol] | OP_CHECKSIG OP_OVER | |
| [symbol] sigᵣ_{₀}ALL [symbol] [symbol] r₀ [symbol] | OP_CHECKSIGVERIFY OP_CHECKSIG | |
| | OP_ENDIF | |
| [symbol] sig_{B}_{₀} NONE [symbol] | OP_DUP OP_HASH160 <H(PK_{A}_{₀}) > | r₀ is dropped, |
| [symbol] PK_{B}_{₀} [symbol] [symbol] sigᵣ_{₀}ALL [symbol] | OP_EQUALVERIFY OP_CHECKSIG OP_OVER | swap the top two pairs |
| [symbol] sig_{A}_{₀} SINGLE [symbol] | OP_CHECKSIGVERIFY OP_CHECKSIG | of items |
| [symbol] PK_{A}_{₀} [symbol] | OP_ENDIF | |
| [symbol] sig_{B}_{₀} NONE [symbol] | OP_OVER OP_CHECKSIGVERIFY | Top stack item PK_{A}_{₀} is |
| [symbol] PK_{B}_{₀} [symbol] [symbol] sigᵣ_{₀}ALL [symbol] | OP_CHECKSIG OP_ENDIF | duplicated, |
| | | duplicated PK_{A}_{₀} IS |
| | | hashed, |
| | | check if |
| | | duplicated PK_{A}_{₀} = |
| | | H(PK_{A}_{₀}), |
| | | signature |
| | | <sig_{A}_{₀} SINGLE> is |
| | | checked for top two |
| | | stack items. |
| [symbol] sig_{B}_{₀} NONE [symbol] [symbol] PK_{B}_{₀} [symbol] | OP_CHECKSIGVERIFY OP_CHECKSIG | Copy the second-to-top |
| [symbol] sigᵣ_{₀}ALL [symbol] [symbol] PK_{B}_{₀} [symbol] | OP_ENDIF | stack item PK_{B}_{₀} to the |
| | | top |
| [symbol] sig_{B}_{₀} NONE [symbol] [symbol] PK_{B}_{₀} [symbol] | OP_CHECKSIG OP_ENDIF | Script checks |
| | | <sigᵣ_{₀} ALL> against |
| | | <PK_{B}_{₀}> |
| true | empty | < sig_{B}_{₀} NONE > is |
| | | checked against |
| | | <PK_{B}_{₀}> |

Similarly, if r₁ is revealed by the worker Bob₀ in the TxID₁, and then the corresponding unlocking script would be:

[symbol]

sig_{B}_{₀}NONE [symbol] [symbol] sig_{A}_{₁}SINGLE [symbol] [symbol] PK_{A}_{₁} [symbol] [symbol] PK_{B}_{₀} [symbol] [symbol] sigᵣ_{₁}ALL

[symbol]

To sum up, including the signature <sigᵣALL> using r in the unlocking script is a possible solution to ensure that a malicious blockchain node cannot claim the payment because the blockchain node will not be able to forge the signature using r unless it knows the private key used in that signature.

In the R-puzzle solution, the metadata k is directly linked to the r value. This will cause another security concern; a third-party Dave knowing k may claim the funds intentionally without doing any calculations. In this case, the payment is claimed but Alice 103a doesn't know whether it was paid to the person who did the work to produce the validation. This is unfair for workers who do the calculations but do not get paid because the funds are claimed by Dave before any workers.

To prevent Dave from claiming the reward, Alice 103a must make sure that the signed template of the proof of computation transactions will not be shared to Dave who knows the metadata k. Thus, Alice 103a only shares the related information (e.g., the templates of PCTXs) to a predetermined set of workers who are legible to participate the task.

Alice 103a has determined the sequence of k values when generating the R-puzzle in the task transaction. Alice's motivation of doing this is to have as many values of k as possible to be verified by the workers. The workers may not know the sequence of k values embedded in the puzzle while performing the calculations. This means that the workers are likely to have to verify more k values in order to derive a verification value for satisfying a subscript of the locking script, and therefore Alice 103a is more likely to receive verification of all data values k.

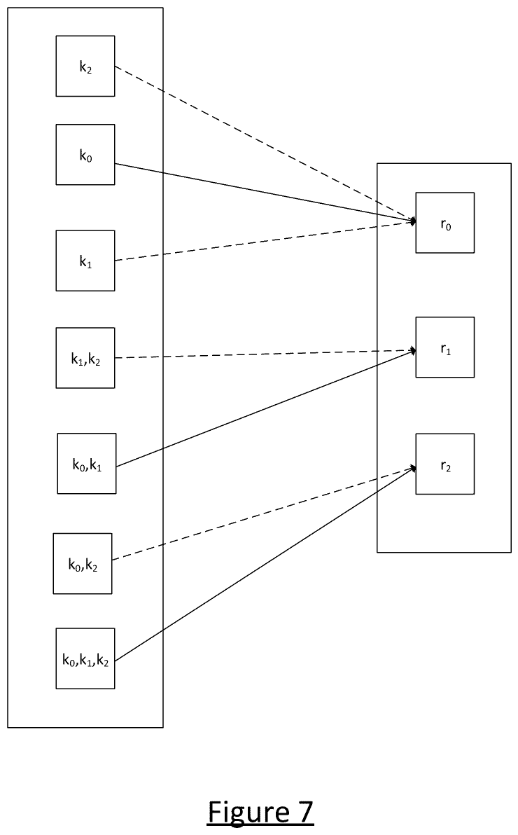

An example is shown in FIG. 7, which shows the combination of data values but derive in order to generate each of the verification values. The solid arrows of FIG. 7 represent valid derivations, whereas the dashed arrows represent invalid derivations.

Bob 103b can't get r₀ if he finds k₁ or k₂ first, and nor can he get r₁ or r₂ without k₀. That means, when a worker finds a first k value, the do not know whether the found k value is k₀. Thus, a worker may need to find as many k values as possible to get the values of r, so as to get r₂ as quickly as possible to obtain as many service fees as possible.

### 8.5 Example Use Case

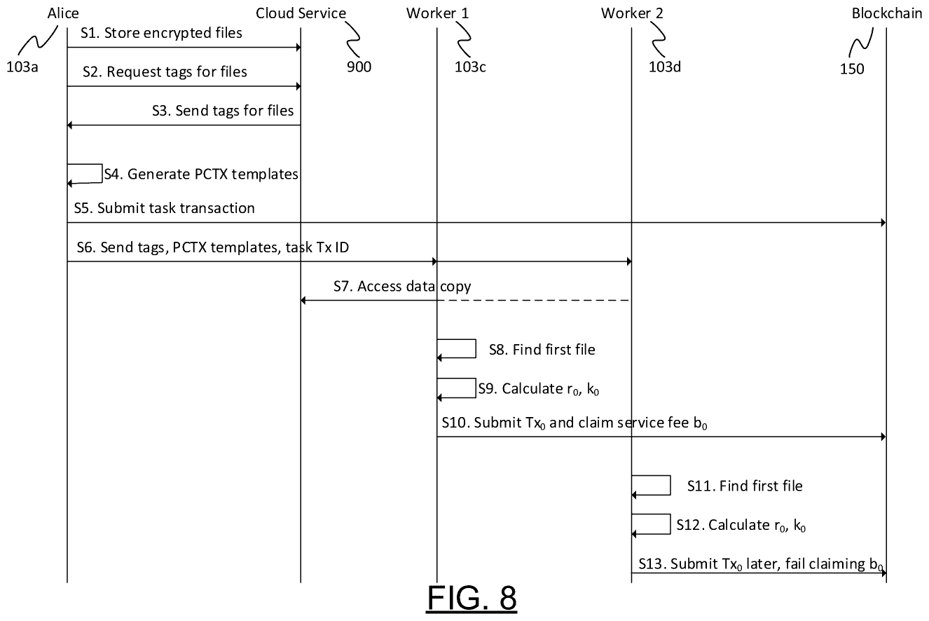

An example use case is provided in FIG. 8. Alice 103a is a user of a cloud service 900 for storing data. Alice 103a stores her encrypted files onto it. Alice 103a wishes to check the integrity of the stored files on cloud service 900 before deleting the local copy. Thus, Alice 103a outsources the integrity verification to worker 1 103c and worker 2 103d. Worker 1 103c and worker 2 103d are the service providers that are authorized to access to the encrypted data on the cloud service 900.

The process of outsourcing verifications to worker 1 103c and worker 2 103d has been shown in FIG. 8.
1. Alice 103a encrypts two files into k₀=[f₀]_{En} and k₁=[f₁] En and stores these two encrypted files on the could service 900.
2. Alice 103a sends a request to the cloud service 900 to get a tag indicating the location of the stored files on the cloud service 900.
3. The cloud service 900 returns two tags about k₀ and k₁.
4. Alice 103a generates the templates of PCTXs: TxID₀ (template) for k₀ and TxID₁ (template) for k₀ and k₁.
5. Alice 103a generates the R-puzzle task transaction by using k₀ and k₁ and submits the task transaction into the blockchain 150. Data in the OP_RETURN output of the task transaction contains:
   a timestamp-indicates when Alice 103a will send the information to the workers 103c, 103d;
   a Merkle root of all generated templates of TxID₀ (template) and TxID₁ (template); and
   the hash values of tags-indicating that Alice 103a sends the same tags to the workers 103c, 103d.
6. Alice 103a simultaneously sends the tags and the templates of PCTXs to worker 1 103c and worker 2 103d.
7. Worker 1 103c and worker 2 103d have downloaded the whole copy of data stored on the cloud service 900. They start to retrieve the tags and find the corresponding files. It is worth noting that the workers 103c, 103d have to determine when to submit the PCTX and which PCTX is submitted.
8. FIG. 8 shows a simple case in which worker 1 103c find a first data file from the accessed data using the provided tag, corresponding to r₀. However, if worker 1 103c finds k₁ first, calculates a value r=[SHA-256(k₁)·G]ₓ, then the calculated r is not equal to the r₀ of the task transaction. That is, worker 1 103c needs to find k₀ first, and then k₁.
9. Worker 1 103c finds r₀ and k₀.
10. Worker 1 103c submits TxID₁ to the blockchain 150 prior to worker 2 103d and successfully claims the funds b₀.
11. Worker 2 103d finds the first data file, corresponding to r₀.
12. Worker 2 103d finds r₀ and k₀.
13. Worker 2 103d submits TxID₁ to the blockchain 150 after worker 1 103c and therefore fails to claim the reward.

It will be appreciated that, although the steps S11 to S13 are shown to follow steps S8 to S10 of FIG. 8, worker 2 103d may execute steps S11 and S12 at substantially the same time as worker 1 103b executes one or more of steps S8 to S10. Worker 1 103c need only execute step S10, submitting the proof transaction to the blockchain 150, prior to worker 2 103d executing step S13 in order to claim the reward.

In the above examples, two workers 103c, 103d compete to derive the verification value. It will be appreciated that any number of workers may be provided with the tags and proof transaction templates so that they can compete for the task transaction reward.

This outsourcing process can be applied to multiple cloud services 900 for a variety of different data types. For example, Alice 103a may save her photos, working files, and/or other personal information on a third party cloud storage platform, it will be useful for her to outsource the verifications of data integrity instead of downloading all the corresponding copy and doing verifications by herself.

There is a problem that the files cannot be found. In other words, no workers can find the files. In this context, Alice 103a can doubt that the files are not saved properly on the cloud service 900. Alice 103a sets the nLocktime for outsourced computations, thus, she will not wait for a long time for the results. After Alice 103a hasn't received successful results from the workers after a reasonable time has passed for submissions after the nLocktime, she can ask the cloud service to check this issue. If Alice 103a is a malicious user and she always generates a puzzle that references non-existent files, workers will no longer accept Alice's tasks.

Another problem is cheating by both the workers 103c, 103d and Cloud services 900. This problem could be taken into account; a situation similar to someone's credit check. If either workers 103c, 103d or Cloud services 900 have malicious behaviour, they will damage their reputation. Hence, they cannot make money from users in the future.

The method described herein uses the example use case of payments for the data integrity verification on cloud platforms. However, it will be appreciated that the payment protocol could be extended to any type of platforms where outsourcers would like to pay for data integrity verification in a sequential way.

### 9. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of generating a provable task for recording to a blockchain, the provable task for verifying (n+1) data items, the method comprising: generating a task blockchain transaction, wherein the task blockchain transaction comprises a first locking script comprising (n+1) subscripts, each respective subscript defining a different unlocking condition corresponding to a knowledge proof, wherein each unlocking condition is satisfied by a different one of a sequence of (n+1) verification values rᵢ, wherein 0≤i≤n, wherein each subscript comprises a public key corresponding to the corresponding verification values satisfying the unlocking condition of the subscript, wherein the respective subscript, when executed with a first unlocking script of a proof blockchain transaction, is configured to verify a verification value provided in the first unlocking script based on the unlocking condition, the verification value rᵢ being derived from (i+1) data values to be verified; making the task blockchain transaction available to one or more nodes of a blockchain network; generating one or more first proof transaction templates, each first proof transaction template corresponding to a different one of the sequence of verification values, each first proof transaction template comprising a template first unlocking script and an outpoint identifying the first locking script, the template first unlocking script comprising the public key corresponding to the corresponding verification value, wherein the first unlocking script is derived from the template first unlocking script and the corresponding verification value; and making the one or more first proof transaction templates available to a worker.

Statement 2. The method of statement 1, wherein the verification value rᵢ may be generated based on a concatenation of the (i+1) data values.

Statement 3. The method of any preceding statement, wherein the verification value rᵢ may be generated based on a hash of the (i+1) data values.

Statement 4. The method of any preceding statement, wherein the template first unlocking script of the first proof transaction template corresponding to a final verification value In of the sequence of verification values may comprise a first signature flag for signing an input of a first proof transaction comprising the first unlocking script and not an output of the first proof transaction.

Statement 5. The method of any preceding statement, wherein the template first unlocking script of the first proof transaction templates corresponding to one of a first n verification values of the sequence of verification values may comprise a second signature flag for signing an input of the first proof transaction comprising the first unlocking script and an output of the first proof transaction.

Statement 6. The method of any preceding statement, wherein a first output of the first proof transaction template, having a same index as the first unlocking script in the first proof transaction template, may define an amount of digital asset.

Statement 7. The method of statements 5 and 6, wherein the first output may further comprise a second locking script for assigning the amount of digital asset to a provider of the task transaction, wherein a remainder amount is assigned to the worker providing the first proof transaction, the first proof transaction comprising the first proof transaction template and the corresponding verification value, the remainder amount being based on the amount defined in the first output and a reward amount of digital asset defined in the task transaction.

Statement 8. The method of any preceding statement, wherein each first proof transaction template may comprise a different sequence number, the sequence numbers increasing with increasing i, wherein the sequence number of the first proof transaction template corresponding to a final verification value rₙ is largest and the sequence number of the first proof transaction template corresponding to a first verification value r₀ is smallest.

Statement 9. The method of any preceding statement, wherein the first proof transaction template corresponding to rₓ, where 0≤x<n, may further comprise a second locking script, the second locking script comprising (n−x) subscripts, each respective subscript defining a different unlocking condition corresponding to a knowledge proof, wherein each unlocking condition is satisfied by a different one of a set of (n−x) remaining verification values rᵢ, the set of remaining verification values comprising the verification values of the sequence of verification values for which x<i≤n, wherein the respective subscript comprises a public key corresponding to the corresponding remaining verification value, wherein the respective subscript, when executed with a second unlocking script of a second proof blockchain transaction, is configured to verify the remaining verification value provided in the second unlocking script based on the unlocking condition; the method further comprising: generating one or more second proof transaction templates, each second proof transaction template comprising: a template second unlocking script, the template second unlocking script comprising the public key corresponding to the corresponding remaining verification value; and an outpoint identifying the first proof transaction template; and making the one or more second proof transaction templates available to the worker.

Statement 10. The method of any preceding statement, wherein the first unlocking script may comprise the template first unlocking script and the verification value.

Statement 11. The method of any of statements 1 to 9, wherein the first unlocking script may comprise the template first unlocking script, a public key associated with the worker, a signature of the worker derived using the public key of the worker, and a signature of the verification value derived using the public key of the worker.

Statement 12. The method of statement 11, wherein the signature of the worker and the signature of the verification value may be generated based on different signed messages.

Statement 13. The method of statement 11 or statement 12, wherein the signature of the worker may be associated with a first signature flag for signing an input of the first proof transaction comprising the first unlocking script and not an output of the first proof transaction, and wherein the signature of the verification value is associated with a third signature flag for signing all inputs and outputs of the proof transaction.

Statement 14. The method of any of statements 11 to 13, wherein the components of the first unlocking script may be provided in a predefined order, the order being: the signature of the worker derived using the public key of the worker; a signature of a provider of the task blockchain transaction; the public key corresponding to the corresponding verification value; the public key associated with the worker; and the signature of the verification value derived using the public key of the worker.

Statement 15. The method if any preceding statement, wherein the data value may be a hash of a data item.

Statement 16. A computer-implemented method of generating a first proof transaction for recording to a blockchain, the method comprising: accessing one or more first proof transaction templates, each proof transaction template corresponding to a different one of a sequence of (n+1) verification values rᵢ, wherein 0≤i≤n, each proof transaction template comprising a template first unlocking script and an outpoint identifying a first locking script of a task transaction, the template first unlocking script comprising a public key corresponding to the corresponding verification value; deriving one of the sequence of (n+1) verification values rᵢ from (i+1) data values; providing, in a first unlocking script of the first proof transaction, the template unlocking script corresponding to the derived verification value and a value based on the derived verification value; and making the task blockchain transaction available to one or more nodes of a blockchain network.

Statement 17. The method of statement 16, wherein the value based on the derived verification value may be the derived verification value.

Statement 18. The method of statement 16, wherein the value based on the derived verification value may be a signature of a worker generating the proof transaction derived using a public key of the worker and the derived verification value, wherein the method further comprises providing in the first unlocking script the public key associated with the worker and the signature of the worker derived using the public key of the worker and the derived verification value.

Statement 19. Computer equipment comprising: memory comprising one or more memory units; and processing apparatus comprising one or more processing units, wherein the memory stores code arranged to run on the processing apparatus, the code being configured so as when on the processing apparatus to perform the method of any of statements 1 to 18.

Statement 20. A computer program embodied on computer-readable storage and configured so as, when run on one or more processors, to perform the method of any of statements 1 to 18.

1. A computer-implemented method of generating a provable task for recording to a blockchain, the provable task for verifying (n+1) data items, the method comprising:
generating a task blockchain transaction, wherein the task blockchain transaction comprises a first locking script comprising (n+1) subscripts, each respective subscript defining a different unlocking condition corresponding to a knowledge proof, wherein each unlocking condition is satisfied by a different one of a sequence of (n+1) verification values rᵢ, wherein 0≤i≤n, wherein each subscript comprises a public key corresponding to the corresponding verification values satisfying the unlocking condition of the subscript, wherein the respective subscript, when executed with a first unlocking script of a proof blockchain transaction, is configured to verify a verification value provided in the first unlocking script based on the unlocking condition, the verification value rᵢ being derived from (i+1) data values to be verified;
making the task blockchain transaction available to one or more nodes of a blockchain network;
generating one or more first proof transaction templates, each first proof transaction template corresponding to a different one of the sequence of verification values, each first proof transaction template comprising a template first unlocking script and an outpoint identifying the first locking script, the template first unlocking script comprising the public key corresponding to the corresponding verification value, wherein the first unlocking script is derived from the template first unlocking script and the corresponding verification value; and
making the one or more first proof transaction templates available to a worker.

2. The method of claim 1, wherein the verification value rᵢ is generated based on a concatenation of the (i+1) data values.

3. The method of claim 1, wherein the verification value rᵢ is generated based on a hash of the (i+1) data values.

4. The method of claim 1, wherein the template first unlocking script of the first proof transaction template corresponding to a final verification value rₙ of the sequence of verification values comprises a first signature flag for signing an input of a first proof transaction comprising the first unlocking script and not an output of the first proof transaction.

5. The method of claim 1, wherein the template first unlocking script of the first proof transaction templates corresponding to one of a first n verification values of the sequence of verification values comprises a second signature flag for signing an input of the first proof transaction comprising the first unlocking script and an output of the first proof transaction.

6. The method of claim 1, wherein a first output of the first proof transaction template, having a same index as the first unlocking script in the first proof transaction template, defines an amount of digital asset.

7. The method of claim 5, wherein a first output of the first proof transaction template, having a same index as the first unlocking script in the first proof transaction template, defines an amount of digital asset, wherein the first output further comprises a second locking script for assigning the amount of digital asset to a provider of the task transaction, wherein a remainder amount is assigned to the worker providing the first proof transaction, the first proof transaction comprising the first proof transaction template and the corresponding verification value, the remainder amount being based on the amount defined in the first output and a reward amount of digital asset defined in the task transaction.

8. The method of claim 1, wherein each first proof transaction template comprises a different sequence number, the sequence numbers increasing with increasing i, wherein the sequence number of the first proof transaction template corresponding to a final verification value rₙ is largest and the sequence number of the first proof transaction template corresponding to a first verification value r₀ is smallest.

9. The method of claim 1, wherein the first proof transaction template corresponding to rₓ, where 0≤x<n, further comprises a second locking script, the second locking script comprising (n−x) subscripts, each respective subscript defining a different unlocking condition corresponding to a knowledge proof, wherein each unlocking condition is satisfied by a different one of a set of (n−x) remaining verification values rᵢ, the set of remaining verification values comprising the verification values of the sequence of verification values for which x<i≤n, wherein the respective subscript comprises a public key corresponding to the corresponding remaining verification value, wherein the respective subscript, when executed with a second unlocking script of a second proof blockchain transaction, is configured to verify the remaining verification value provided in the second unlocking script based on the unlocking condition;
the method further comprising:
generating one or more second proof transaction templates, each second proof transaction template comprising:
a template second unlocking script, the template second unlocking script comprising the public key corresponding to the corresponding remaining verification value; and
an outpoint identifying the first proof transaction template; and
making the one or more second proof transaction templates available to the worker.

10. The method of claim 1, wherein the first unlocking script comprises the template first unlocking script and the verification value.

11. The method of claim 1, wherein the first unlocking script comprises the template first unlocking script, a public key associated with the worker, a signature of the worker derived using the public key of the worker, and a signature of the verification value derived using the public key of the worker.

12. The method of claim 11, wherein the signature of the worker and the signature of the verification value are generated based on different signed messages.

13. The method of claim 11, wherein the signature of the worker is associated with a first signature flag for signing an input of the first proof transaction comprising the first unlocking script and not an output of the first proof transaction, and wherein the signature of the verification value is associated with a third signature flag for signing all inputs and outputs of the proof transaction.

14. The method of claim 11, wherein components of the first unlocking script are provided in a predefined order, the order being: the signature of the worker derived using the public key of the worker; a signature of a provider of the task blockchain transaction; the public key corresponding to the corresponding verification value; the public key associated with the worker; and the signature of the verification value derived using the public key of the worker.

15. The method of claim 1, wherein the data value is a hash of a data item.

16. A computer-implemented method of generating a first proof transaction for recording to a blockchain, the method comprising:
accessing one or more first proof transaction templates, each proof transaction template corresponding to a different one of a sequence of (n+1) verification values rᵢ, wherein 0≤i≤n, each proof transaction template comprising a template first unlocking script and an outpoint identifying a first locking script of a task transaction, the template first unlocking script comprising a public key corresponding to the corresponding verification value;
deriving one of the sequence of (n+1) verification values rᵢ from (i+1) data values;
providing, in a first unlocking script of the first proof transaction, the template unlocking script corresponding to the derived verification value and a value based on the derived verification value; and
making the task blockchain transaction available to one or more nodes of a blockchain network.

17. The method of claim 16, wherein the value based on the derived verification value is the derived verification value.

18. The method of claim 16, wherein the value based on the derived verification value is a signature of a worker generating the proof transaction derived using a public key of the worker and the derived verification value, wherein the method further comprises providing in the first unlocking script the public key associated with the worker and the signature of the worker derived using the public key of the worker and the derived verification value.

19. (canceled)

20. A computer program embodied on non-transitory computer-readable storage media and configured so as, when run on one or more processors, the one or more processors perform a method of generating a provable task for recording to a blockchain, the provable task for verifying (n+1) data items, the method comprising:
generating a task blockchain transaction, wherein the task blockchain transaction comprises a first locking script comprising (n+1) subscripts, each respective subscript defining a different unlocking condition corresponding to a knowledge proof, wherein each unlocking condition is satisfied by a different one of a sequence of (n+1) verification values rᵢ, wherein 0≤i≤n, wherein each subscript comprises a public key corresponding to the corresponding verification values satisfying the unlocking condition of the subscript, wherein the respective subscript, when executed with a first unlocking script of a proof blockchain transaction, is configured to verify a verification value provided in the first unlocking script based on the unlocking condition, the verification value rᵢ being derived from (i+1) data values to be verified;
making the task blockchain transaction available to one or more nodes of a blockchain network;
generating one or more first proof transaction templates, each first proof transaction template corresponding to a different one of the sequence of verification values, each first proof transaction template comprising a template first unlocking script and an outpoint identifying the first locking script, the template first unlocking script comprising the public key corresponding to the corresponding verification value, wherein the first unlocking script is derived from the template first unlocking script and the corresponding verification value; and
making the one or more first proof transaction templates available to a worker.
